(19) United States
(12) Patent Application Publication
(10) Pub. No.: US 2011/0150565 A1
(43) Pub. Date: Jun. 23, 2011

(54) Quick release launch connector for micro unmanned aerial vehicle

(76) Inventor: Itzhak Sapir, Irvine, CA (US)

(21) Appl. No.: 12/928,796

(22) Filed: Dec. 16, 2010

Related U.S. Application Data
(60) Provisional application No. 61/284,394, filed on Dec. 18, 2009.

(51) Int. Cl. F16B 2/10

(52) U.S. Cl. 403/344

(57) ABSTRACT

The invention comprises a clamping mechanism comprising a first and second hinged retaining members for the receiving of a terminal member of a connecting rod. The terminal member is affixed within a retaining volume defined by the first and second hinged retaining members while in a closed first position when the clamping mechanism is disposed within a retaining structure.

During a launch operation, a drive shaft urges the clamping mechanism forward of the retaining structure, permitting the retaining members to separate and releasing the retaining member. The connecting rod may be connected to and used to propel a micro-UAV or any other device, such as during a launch operation.

### CROSS-REFERENCE TO RELATED APPLICATIONS

This application claims the benefit of U.S. Provisional Patent Application No. 61/284,394, filed on Dec. 18, 2009 entitled “Quick Release Launch System” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of mechanical connectors. Specifically, the invention relates to a quick release mechanical connector which may be used, for instance, in micro-air vehicle (“MAV”) applications.

2. Description of the Related Art

A tube launched micro-air vehicle is stored inside the bore of a launch tube prior to being launched and encounters significant vibration while being transported to a launch site. Because of the rugged handling of the tube and micro-air vehicle in a combat or training operation, there is a need to securely affix the MAV within the launch tube during travel while at the same time easily and quickly disengage during a launch operation.

The invention as described below is a simple mechanism for safely securing the MAV in place while in transit while easily releasing the MAV during a launch operation. Both operations are achieved automatically. There are no such devices known in the prior art.

### BRIEF SUMMARY OF THE INVENTION

The invention comprises a clamping mechanism comprising first and second hinged retaining members for the receiving of a terminal member of a connecting rod. The terminal member is affixed within a retaining volume defined by the first and second hinged retaining members while in a closed first position when the clamping mechanism is disposed within a retaining structure. During a launch operation, a drive shaft urges the clamping mechanism forward of the retaining structure, permitting the retaining members to separate and releasing the retaining member. The connecting rod may be used to propel a micro-UAV or any other device, such as during a launch operation.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts the quick release connector of the invention in a first closed position.

FIG. 2 depicts the quick release connector of the invention in a second closed position.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Turning now to the figures wherein like numerals define like elements among the several views, a quick release connector 1 is disclosed.

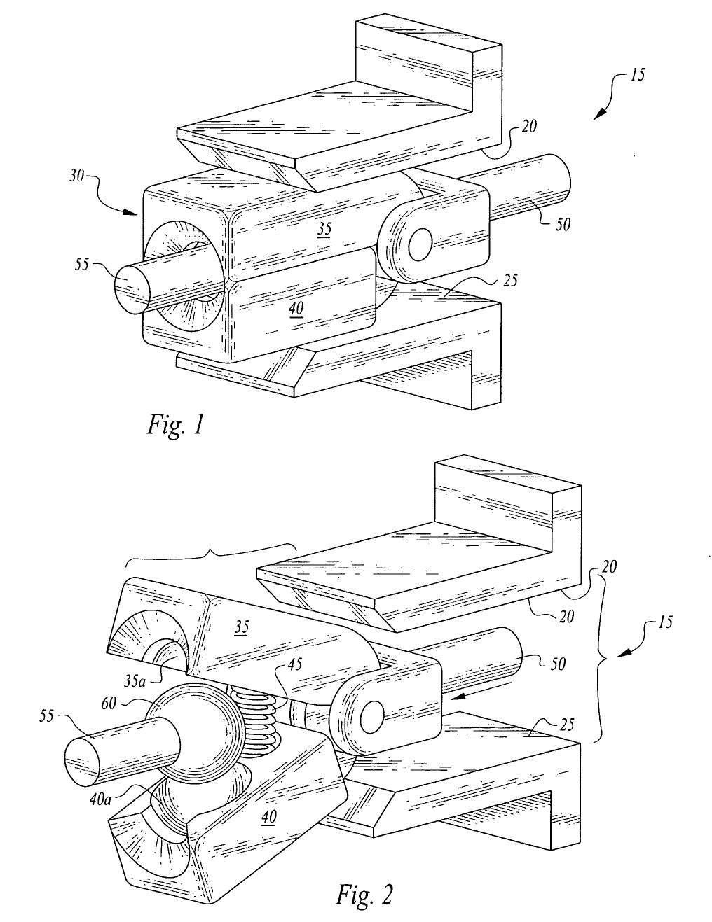

FIG. 1 illustrates a preferred embodiment of quick release connector 1 in a first closed position 5 and FIG. 2 illustrates quick release connector 1 in a second open position 10.

Quick release connector 1 comprises retaining structure 15, which, in this depiction, comprises a first surface 20 and a second surface 25 which are substantially parallel to each other and are disposed at a predefined, spaced apart distance.

Quick release connector 1 further comprises a clamping mechanism 30 comprising a first retaining member 35 and a second retaining member 40 each of which define a partial retaining volume 35a and 40a. First retaining member 35 and a second retaining member 40 are hinged so as to enable the two retaining members to open and close as seen in FIGS. 1 and 2 respectively.

A bias means such as a mechanical spring 45 is provided to permit opening or separating of the first and second retaining members when the clamping mechanism is in the second open position.

Quick release connector 1 further comprise a drive shaft 50 wherein the drive shaft may selectively urge clamping mechanism 30 forward of retaining structure 15 to a second open position.

Quick release connector 1 further comprise a connecting rod 55 having a terminal member 60 which is received within the volume that is defined by first and second retaining volumes 35a and 40a when clamping mechanism 30 is in the first closed position. Terminal member 60 is preferably a spherical member and the defined retaining volume is preferably a spherical volume.

In operation, in the first closed position of FIG. 1, clamping mechanism 30 is retained within first and second surfaces 20 and 25 such that first clamping member 35 and second clamping member 40 are urged together against the force of bias means 45 and define a retaining volume. In the first closed position, terminal member 60 of connecting rod 55 is clamped within or retained by and within the defined retaining volume.

In a release operation, such as the launching of an MAV, drive shaft 50 is urged forward using, for instance, compressed air or mechanical means. Drive rod 50 thus moves clamping mechanism 30 forward of retaining structure 15, at which point, bias means 45 urges first and second retaining members 35 and 40 to a second open position, releasing the connecting rod concurrent with the launch operation.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A quick release connector comprising:
a connecting rod comprising a terminal member,
a clamping mechanism comprising first and second hinged retaining members defining a retaining volume for the receiving of the terminal member whereby the terminal member is retained within the retaining volume when the clamping mechanism is disposed within a retaining structure in a first closed position,
a drive shaft wherein the drive shaft selectively urges the clamping mechanism forward of the retaining structure to a second open position,
bias means for separating the first and second retaining members when the clamping mechanism is in the second open position.
